(19) United States
(12) Patent Application Publication
(10) Pub. No.: US 2025/0240247 A1
(43) Pub. Date: Jul. 24, 2025

(54) QUALITY OF SERVICE SETUP IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 19/025,279

(22) Filed: Jan. 16, 2025

Related U.S. Application Data
(60) Provisional application No. 63/624,656, filed on Jan. 24, 2024.

(51) Int. Cl. H04L 47/24; H04L 43/0805

(52) U.S. Cl. CPC H04L 47/24; H04L 43/0805

(57) ABSTRACT

A first station (STA) and a second STA have traffic between them. The first STA requests the AP to establish a quality of service (QoS) flow for the second STA. The request indicates QoS parameters corresponding to the QoS flow that is requested to establish on behalf of the second STA. AP performs a QoS setup for the second STA in response to the request.

### CROSS-REFERENCE TO RELATED APPLICATION(S)

This application claims the benefit of priority from U.S. Provisional Application No. 63/624,656, entitled “TRUST MECHANISOM FOR QOS SETUP,” filed Jan. 24, 2024, which is incorporated herein by reference in its entirety.

### TECHNICAL FIELD

This disclosure relates generally to a wireless communication system, and more particularly to, for example, but not limited to, Quality of Service (QoS) setup in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first station (STA) in a wireless network. The first STA comprises a memory and a processor coupled to the memory. The processor is configured to cause: transmitting, to an access point (AP), a first request frame that requests the AP to establish a quality of service (QoS) flow for a second STA, the first request frame including QoS parameters associated with the QoS flow; and receiving, from the AP, a first response frame in response to the first request frame.

In some embodiments, the processor is further configured to cause transmitting, to the AP, a declaration frame indicating that the second STA authorizes the first STA to establish the QoS flow on behalf of the second STA.

In some embodiments, the declaration frame includes a list of identifiers for one or more STAs, including the second STA.

In some embodiments, the processor is further configured to cause: transmitting, to the second STA, a second request frame that requests permission to establish the QoS flow on behalf of the second STA; and receiving, from the second STA, a second response frame that indicates permission to establish the QoS flow on behalf of the second STA.

In some embodiments, the processor is configured to cause: transmitting, to the AP, the first request frame that requests the AP to establish QoS flows for a group of one or more second STAs, the first request frame includes QoS parameters associated with the QoS flow for the group; and receiving, from the AP, the first response frame in response to the first request frame.

In some embodiments, the first request frame includes an identifier for the group of the one or more second STAs.

An aspect of the disclosure provides an access point (AP) in a wireless network. The AP comprises a memory and a processor coupled to the memory. The processor is configured to cause: receiving, from a first station (STA), a first request frame that requests the AP to establish a quality of service (QoS) flow for a second STA, the first request frame including QoS parameters associated with the QoS flow; transmitting, to the first STA, a first response frame in response to the first request frame; and establishing the QoS flow for the second STA based on the QoS parameters included in the first request frame.

In some embodiments, the processor is further configured to cause receiving, from the first STA, a declaration frame indicating that the second STA has authorized the first STA to establish the QoS flow on behalf of the second STA.

In some embodiments, the processor is further configured to cause receiving, from the second STA, a declaration frame indicating that the second STA has authorized the first STA to establish the QoS flow on behalf of the second STA.

In some embodiments, the processor is further configured to cause: transmitting, to the second STA, a verification request frame to verify whether the second STA has authorized the first STA to establish the QoS flow on behalf of the second STA; and receiving, from the second STA, a verification response frame to confirm that the second STA has authorized the first STA to establish the QoS flow on behalf of the second STA.

In some embodiments, the declaration frame includes a list of identifiers of one or more STAs, including the second STA.

In some embodiments, the processor is configured to cause: receiving, from the AP, the first request frame that requests the AP to establish QoS flows for a group of one or more second STAs, the first request frame includes QoS parameters associated with the QoS flow for the group; and transmitting, to the AP, the first response frame in response to the first request frame.

In some embodiments, the first request frame includes an identifier for the group of the one or more second STAs.

In some embodiments, the processor is further configured to cause allocating, to the group of the one or more second STAs, a transmission opportunity (TXOP) in response to the first request frame.

An aspect of the disclosure provides a method performed by a first station (STA) in a wireless network. The method comprises: transmitting, to an access point (AP), a first request frame that requests the AP to establish a quality of service (QoS) flow for a second STA, the first request frame including QoS parameters associated with the QoS flow; and receiving, from the AP, a first response frame in response to the first request frame.

In some embodiments, the method further comprises transmitting, to the AP, a declaration frame indicating that the second STA has authorized the first STA to establish the QoS flow on behalf of the second STA.

In some embodiments, the declaration frame includes a list of identifiers for one or more STAs, including the second STA.

In some embodiments, the method further comprises: transmitting, to the second STA, a second request frame that requests permission to establish the QoS flow on behalf of the second STA; and receiving, from the second STA, a second response frame that indicates permission to establish the QoS flow on behalf of the second STA.

In some embodiments, the method further comprises: transmitting, to the AP, the first request frame that requests the AP to establish QoS flows for a group of one or more second STAs, the first request frame including QoS parameters associated with the QoS flow for the group; and receiving, from the AP, the first response frame in response to the first request frame.

In some embodiments, the first request frame includes an identifier for the group of the one or more second STAs.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example scenario for QoS setup in accordance with an embodiment.

FIG. 6 shows an example process for establishing a QoS flow in accordance with an embodiment.

FIG. 7 shows an example process for establishing QoS in accordance with an embodiment.

FIG. 8 shows an example process for setting up QoS trust between two STAs in accordance with an embodiment.

FIG. 9 shows an example process for establishing a QoS flow in accordance with an embodiment.

FIG. 10A shows an example of a QoS characteristic element in accordance with an embodiment.

FIG. 10B shows an example of a Control Info field within the QoS characteristic element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

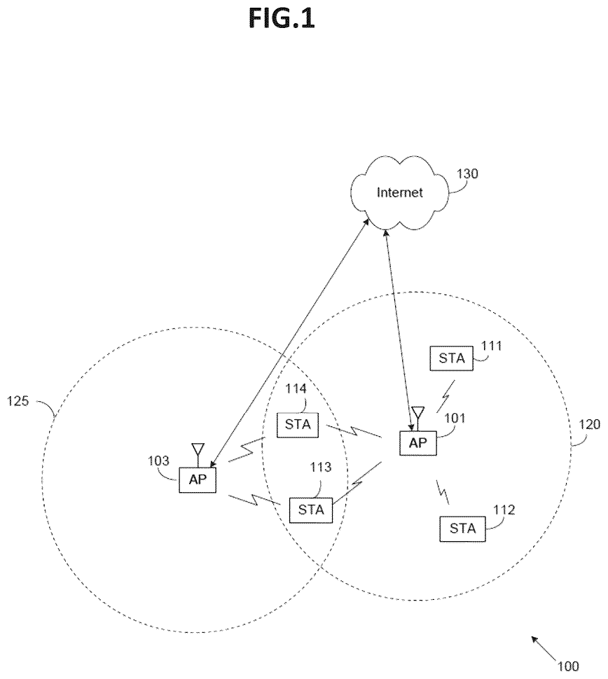

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

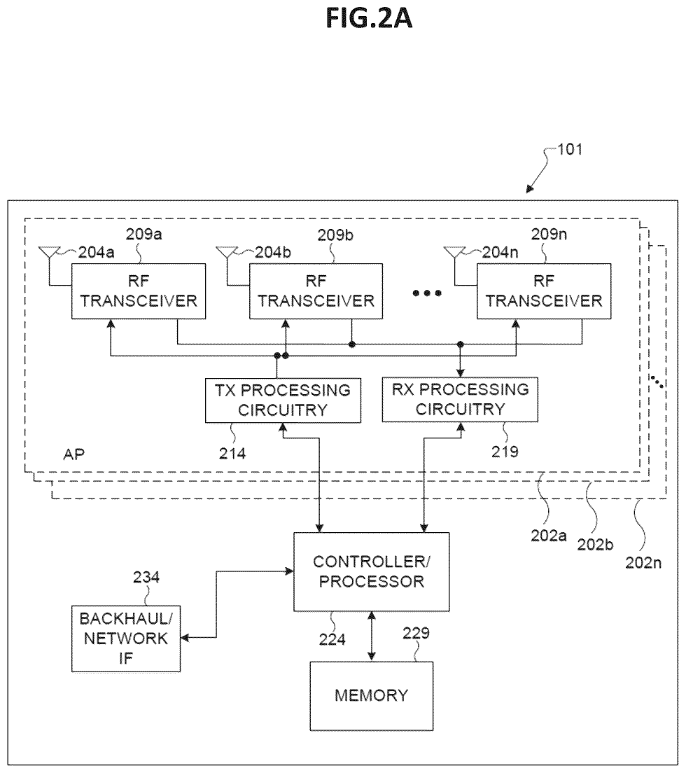

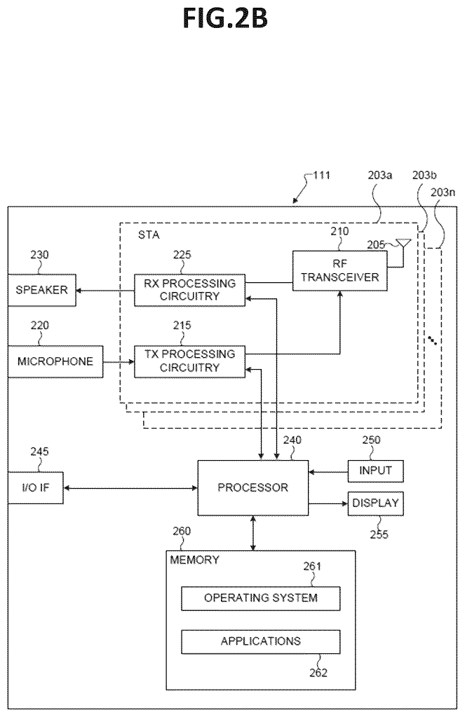

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

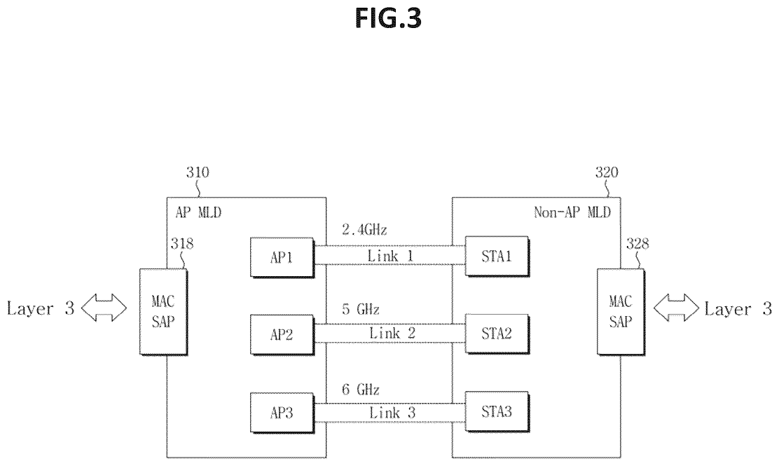

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

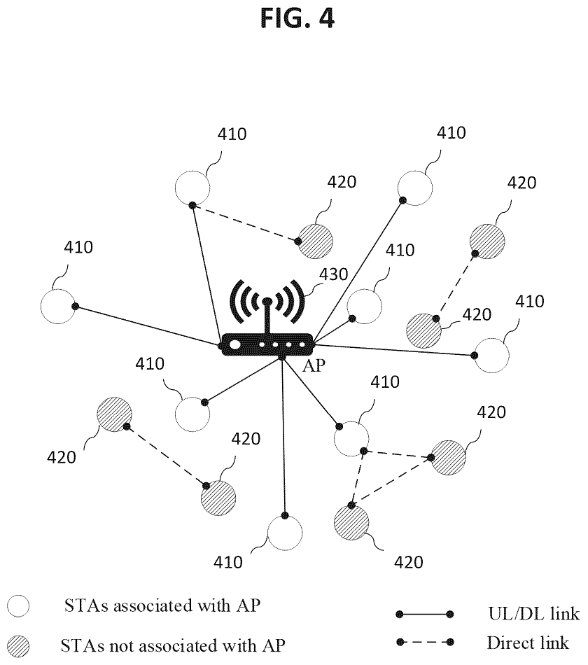

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 are non-AP STAs associated with AP 430, and a plurality of STAs 420 are non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network. Many of these devices may have a tolerance for latency, but still compete with the devices running low-latency applications for the same time and frequency resources. In some cases, the AP as a network controller may not have enough control over the unregulated or unmanaged traffic that contends with the low-latency traffic within the infrastructure basic service set (BSS). In some embodiments, the infrastructure BSS is a basic service set that includes an AP and one or more non-AP STAs, while the independent BSS is a basic service set where non-AP STAs communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

Conventional WLAN systems lack a mechanism to establish trust for setting up QoS with an AP on behalf of another STA.

The present disclosure provides a mechanism, including various embodiments, to establish trust for QoS establishment for another STA.

In some embodiments, two non-AP STAs (e.g., a first non-AP STA and a second non-AP STA) have traffic between them, such as latency-sensitive traffic for augmented reality (AR) or virtual reality (VR) applications. When both non-AP STAs are associated with the same AP, the first non-AP STA may request the AP to establish a QoS flow for the second non-AP STA. In order to request to establish the QoS flow on behalf of the second non-AP STA, the first non-AP STA may send a stream classification service (SCS) request frame to the associated AP. In an embodiment, the request frame may be any frame transmitted from the first non-AP STA to the AP. For convenience, the request frame may be referred to as a QoS setup request frame in this disclosure. The QoS setup request frame may include information similar to that in the SCS request frame and, additionally, may include one or more QoS characteristic elements to specify or indicate the QoS parameters corresponding to the QoS flow requested on behalf of the second non-AP STA.

In some embodiments, a first non-AP STA requests establishment of a QoS flow on behalf of a second non-AP STA by sending a QoS setup request frame or a SCS request frame to an AP. The QoS setup request frame or the SCS request frame may include i) an identification (or identifier) of the second non-AP STA and/or ii) a secret key or a verification code. The identification of the second non-AP STA may be, for example and without limitation, an association identifier (AID), an STA ID, or a MAC address, or a MLD MAC address corresponding to the second non-AP STA. The secret key or the verification code may indicate that the second non-AP STA trusts or authorizes the first non-AP STA in terms of the QoS setup on behalf of the second non-AP STA. In an embodiment, the second non-AP STA may share the secret key or the verification code with the AP. Therefore, upon receiving the secret key or the verification code of the second non-AP STA from the first non-AP STA, the AP may decide to trust the first non-AP STA to establish the QoS flow on behalf of the second non-AP STA. This process allows the AP to verify that the first non-AP STA has obtained permission from the second non-AP STA to establish the QoS flow on its behalf.

In some embodiments, when the first non-AP STA establishes a QoS flow on behalf of the second non-AP STA, both the first non-AP STA and the second non-AP STA need to be associated with the same AP.

In some embodiments, when the first non-AP STA establishes a QoS flow on behalf of the second non-AP STA, the first non-AP STA needs to be associated with the AP, whereas the second non-AP STA may not need to be associated with the same AP.

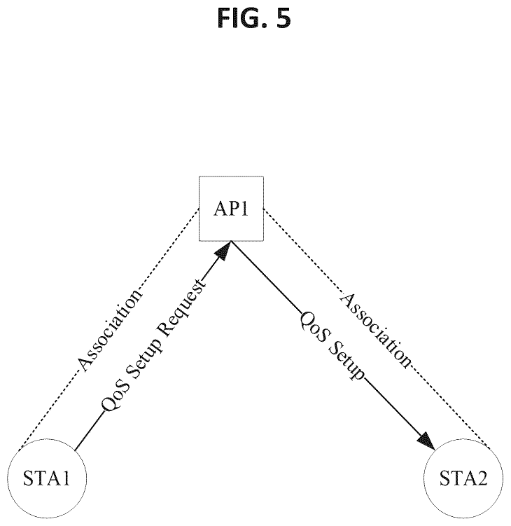

FIG. 5 shows an example scenario for a QoS setup in accordance with an embodiment.

Referring to FIG. 5, STA 1 and STA 2 are associated with AP 1. STA 1 and STA 2 may have traffic to each other. STA 1 may send a QoS setup request frame to AP 1 to request a QoS flow on behalf of STA 2. In response, AP 1 may initiate a QoS setup procedure for STA 2. FIG. 5 illustrates an example where both STAs are associated with the same AP, and STA 1 requests a QoS setup for STA 2.

In some embodiments, a first non-AP STA establishes a QoS flow on behalf of a second non-AP STA. The second non-AP STA sends a QoS trust declaration to an AP. In the QoS trust declaration, the second non-AP STA informs the AP of a list of non-AP STAs, including the first non-AP STA, that the second non-AP STA trusts to establish a QoS flow on behalf of the second non-AP STA. In an embodiment, both the first non-AP STA and the second non-AP STA may share the QoS trust declaration with the AP. In order to send the QoS trust declaration, the non-AP STAs may send a QoS trust declaration frame to the AP. The QoS trust declaration frame may include information about trusted non-AP STAs (e.g., identifications of non-AP STAs). The identification may include, for example and without limitation, a STA ID, a MAC address, a MLD address, an AID of the trusted non-AP STAs. In an embodiment, the QoS trust declaration may include the identifications of the non-AP STAs that trust the transmitting non-AP STA.

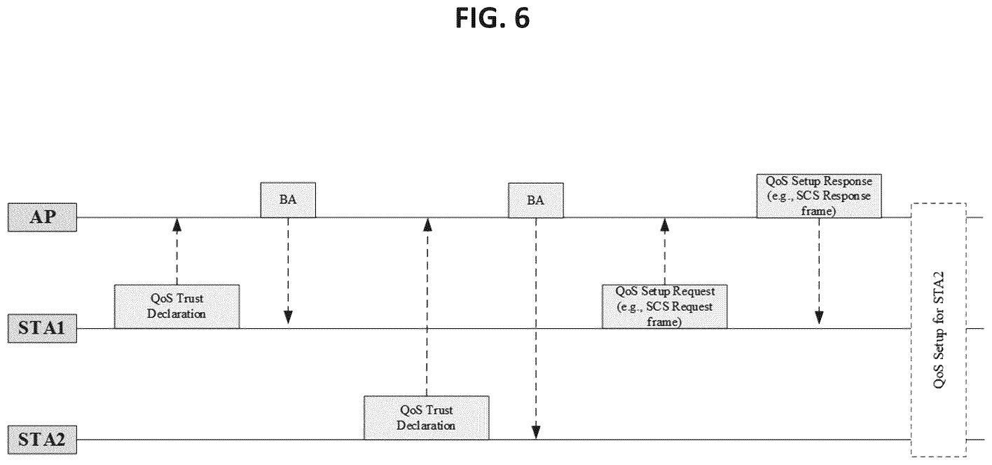

FIG. 6 shows an example process for establishing a QoS flow in accordance with an embodiment.

Referring to FIG. 6, STA 1 sends a first QoS trust declaration frame to AP 1. In an embodiment, the first QoS trust declaration may include information indicating a list of STAs, including STA 2, which trust or authorize STA 1 to establish QoS on their behalf. In response, AP sends an acknowledgment to STA 1, such as a Block Ack (BA). Subsequently, STA 2 sends a second QoS trust declaration frame to AP. In an embodiment, the second QoS trust declaration frame may include information indicating a list of STAs, including STA 1, that STA 2 trusts or authorizes to establish QoS on its behalf. In response, AP responds to STA 2 with BA. Then, STA 1 sends a QoS setup request frame to AP to request the establishment of QoS flow on behalf of STA 2. The QoS setup request frame may be, for example, an SCS request frame. In response, AP sends a QoS setup response frame to STA 1. The QoS setup response frame may include a response to the QoS setup request, such as accept, reject, or alternative suggestion. The QoS setup response frame may be an SCS response frame. Then, AP perform QoS setup process to establish the QoS flow for STA 2.

In some embodiments, AP receives a QoS trust declaration from a first non-AP STA, which identifies a second non-AP STA and indicates that the second non-AP STA trusts the first non-AP STA to establish the QoS flow for the second non-AP STA. AP may send a message to the second non-AP STA to verify whether the second STA trusts the first non-AP STA to establish the QoS flow on behalf of the second non-AP STA. In an embodiment, AP may send a QoS trust verification frame to the second non-AP STA, including the identification for the first non-AP STA. Subsequently, the second non-AP STA may send a QoS trust verification response frame to AP to confirm or reject the trust for the first non-AP STA.

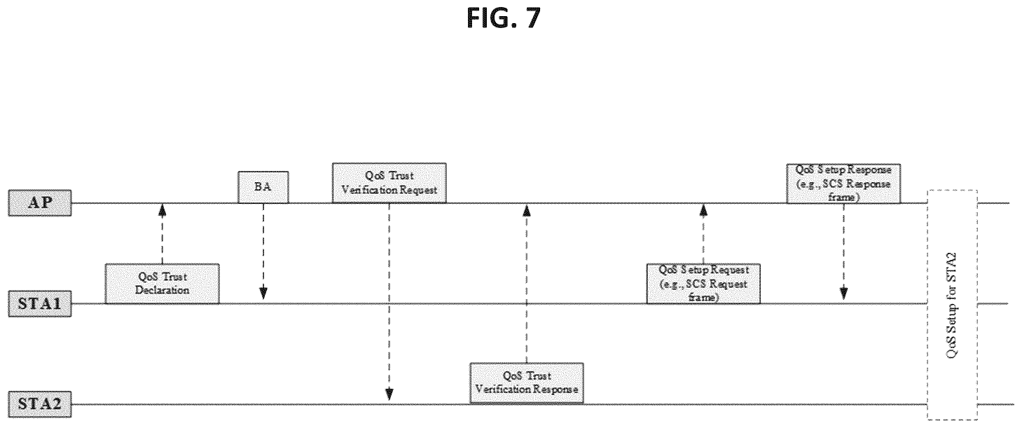

FIG. 7 shows an example process for establishing QoS in accordance with an embodiment.

Referring to FIG. 7, STA 1 sends a QoS trust declaration frame to AP 1. The QoS trust declaration frame includes an identification of STA 2 and indicates that STA 2 has authorized STA 1 to establish a QoS flow on its behalf. AP responds with a BA frame. Subsequently, AP sends a QoS trust verification request frame to STA 2 to verify if STA 2 trusts or authorizes STA 1 to set up the QoS flow on behalf of STA 2. In an embodiment, the QoS trust verification request frame includes the identification for STA 1. In response, STA 2 sends a QoS trust verification response frame to AP, either confirming or rejecting the trust an authorization of STA 1. Following this, STA 1 sends a QoS setup request frame (e.g., SCS request frame) to AP, then AP responds to STA 1 with a QoS setup response frame (e.g., SCS response frame). Then, AP performs a QoS setup procedure for STA 2. Compared to the example illustrated in FIG. 6, the example in FIG. 7 introduces an additional verification process for STA 1.

In some embodiments, a first non-AP STA and a second non-AP STA may exchange a QoS trust setup request frame and a QoS trust response frame to establish a trust relation between them. In an implementation, the first non-AP STA may send a QoS trust setup request frame to the second non-AP STA to request permission from the second non-AP STA to establish a QoS flow with AP for the second non-AP STA. In response, the second non-AP STA may send a QoS trust setup response frame to the first non-AP STA to provide permission to the first non-AP STA to establish a QoS flow with AP on behalf of the second non-AP STA.

In some embodiments, the QoS trust setup request frame and the QoS trust setup response frame may include a secret key or a verification code that a first non-AP STA shares with AP to establish a QoS flow on behalf of a second non-AP STA. The non-AP STAs may also share the secret key or the verification code with the AP through separate frame exchanges. This embodiment enables AP to verify the authenticity of the QoS flow setup request initiated by the first non-AP STA on behalf of the second non-AP STA.

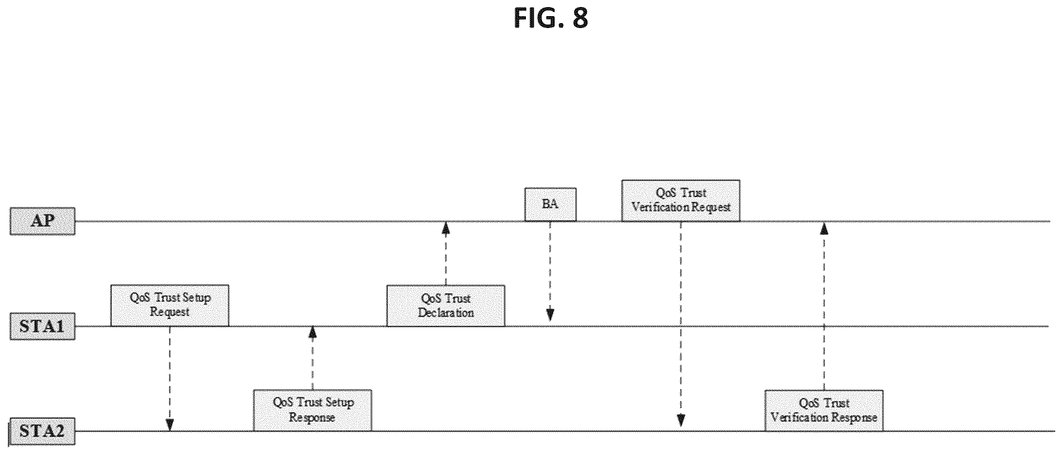

FIG. 8 shows an example process for setting up QoS trust between two STAs in accordance with an embodiment.

Referring to FIG. 8, STA 1 sends a QoS trust setup request frame to STA 2. The QoS trust setup request frame may request permission from STA 2 to establish a QoS flow for STA 2. In response, STA 2 sends a QoS trust setup response frame to STA 1. The QoS trust setup response frame may provide permission to STA 1 to establish the QoS flow with AP on behalf of STA 2. Subsequently, STA 1 sends a QoS trust declaration frame to AP. In response, AP sends a BA frame, and then a QoS trust verification request frame to STA 2. In response, STA 2 sends a QoS trust verification response frame. Following this, AP performs a QoS setup procedure for STA 2.

In some embodiments, when AP receives a QoS setup request frame from a first non-AP STA on behalf of a second non-AP STA, AP may send a verification request to the second non-AP STA to confirm whether the second non-AP STA trusts or has authorized the first non-AP STA for the QoS setup.

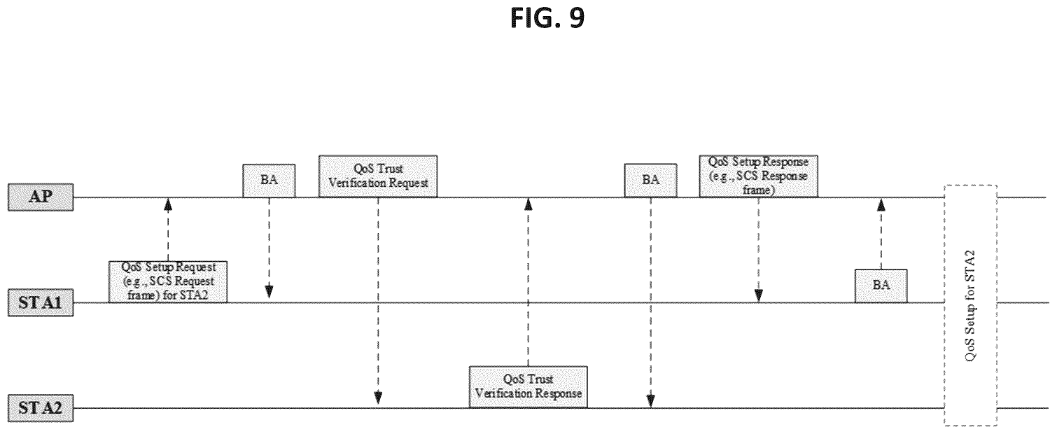

FIG. 9 shows an example process for establishing a QoS flow in accordance with an embodiment.

Referring to FIG. 9, STA 1 sends a QoS setup request frame to AP to establish a QoS flow on behalf of STA 2. The QoS setup request frame may be an SCS request frame. AP sends a BA frame to STA 1. Subsequently, AP sends a QoS trust verification request to STA 2 to verify if STA 2 trust or has authorized STA 1 for establishing the QoS flow on behalf of STA 2. In response, STA 2 sends a QoS trust verification response frame to confirm the trust to STA 1. AP sends a BA frame. Subsequently, AP sends a QoS setup response frame to STA 1 in response to the QoS setup request frame. The QoS setup response frame may be an SCS response frame. In response, STA sends a BA frame. Following this, AP performs QoS setup process for STA 2.

In some embodiments, a first non-AP STA may set up a QoS request with its associated AP on behalf of one or more second non-AP STAs (i.e., a group of non-AP STAs). In order to set up a trust or authorization for the group of non-AP STAs, the first non-AP STA may include a group identifier in the QoS setup request frame. In an embodiment, when non-AP STAs form a P2P group, a corresponding P2P group identifier may be included in the QoS setup request frame transmitted to AP.

In some embodiments, when AP agrees to set up QoS flow for the group of non-AP STAs, AP may allocate resources, such as transmission opportunity (TXOP), on a per-group basis. In an embodiment, a P2P group identifier for the group of non-AP STAs may be used to allocate the resources, instead of an identifier (e.g., STA ID) of any particular STA within the group.

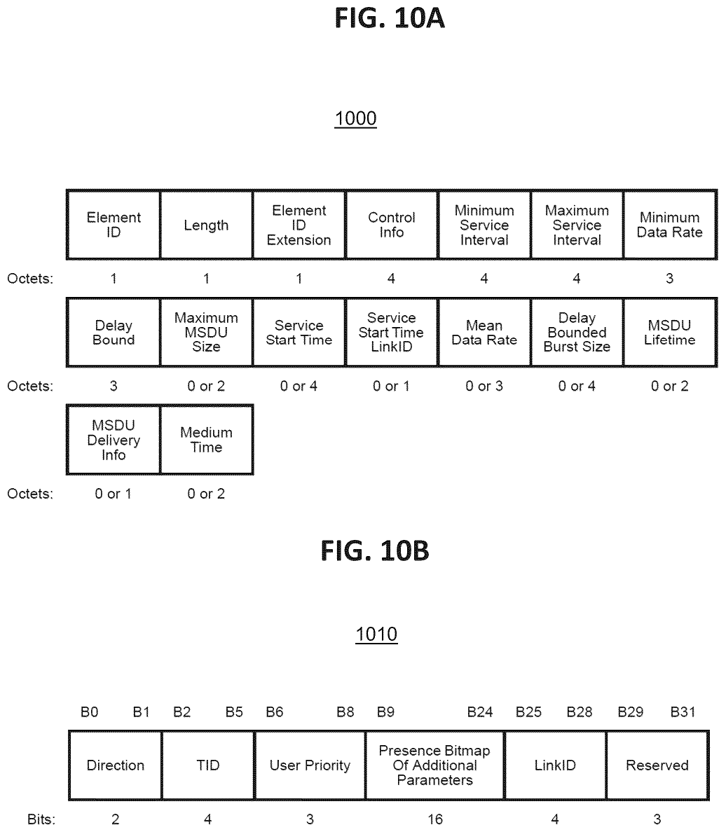

FIG. 10A shows an example of a QoS characteristic element and FIG. 10B shows an example of a Control Info field within the QoS characteristic element in accordance with an embodiment. The QoS characteristic element may include QoS parameters that are used to establish a QoS flow. The QoS characteristic element may be included in the QoS setup request frame or/and the QoS setup response frame described in this disclosure.

Referring to FIG. 10A, the QoS characteristic element 1000 includes an Element ID field, a Length field, an Element ID Extension field, a Control field, a Maximum Service Interval field, a Minimum Service Interval field, a Minimum Date Rate field, a Delay Bound field, a Maximum MSDU Size field, a Service Start Time field, a Service Start Time Link ID field, a Mean Date Rate field, a Delay Bounded Burst Size field, a MSDU Lifetime field, a MSDU Delivery Info field, and Medium Time field.

Referring to FIG. 10B, the Control Info field 1010 includes a Direction subfield, a TID subfield, a User Priority subfield, a Presence Bitmap of Additional Parameters subfield, a Link ID subfield, and Reserved bits. The Direction subfield indicates the direction of data, such as uplink, downlink, or direct link. The direct link indicates that frames, more specifically MSDUs or A-MSDUs, are sent over a P2P link to a peer STA. The TID subfield indicates a TID value of data frame described by the QoS characteristic element 1000. The User Priority subfield indicates the user priority value (0-7) of the data frames described by the QoS characteristic element 1000. The Presence Bitmap Of Additional Parameters subfield indicates a bitmap where the i-th entry of the bitmap is set to 1 if the i-th field starting from the Maximum MSDU Size field is present in QoS characteristic element 1000. The Link ID subfield contains the link identifier that corresponds to the link for which the direct link transmissions are going to occur.

The Minimum Service Interval field in FIG. 10A may indicate the minimum interval between the start of two consecutive service periods that are allocated to the STA for direct link frame exchanges when the Direction subfield in FIG. 10B is set to the direct link.

The Maximum Service Interval field in FIG. 10A may indicate the maximum interval between the start of two consecutive service periods that are allocated to the STA for direct link frame exchanges when the Direction subfield in FIG. 10B is set to the direct link.

According to various embodiments in this disclosure, a non-AP STA can establish a QoS flow on behalf of another non-AP STA. The disclosure provides a mechanism for establishing QoS for another non-AP STA.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to cause:
transmitting, to an access point (AP), a first request frame that requests the AP to establish a quality of service (QoS) flow for a second STA, the first request frame including QoS parameters associated with the QoS flow; and
receiving, from the AP, a first response frame in response to the first request frame.

2. The first STA of claim 1, wherein the processor is further configured to cause:
transmitting, to the AP, a declaration frame indicating that the second STA authorizes the first STA to establish the QoS flow on behalf of the second STA.

3. The first STA of claim 2, wherein the declaration frame includes a list of identifiers for one or more STAs, including the second STA.

4. The first STA of claim 2, wherein the processor is further configured to cause:
transmitting, to the second STA, a second request frame that requests permission to establish the QoS flow on behalf of the second STA; and
receiving, from the second STA, a second response frame that indicates permission to establish the QoS flow on behalf of the second STA.

5. The first STA of claim 1, wherein the processor is configured to cause:
transmitting, to the AP, the first request frame that requests the AP to establish QoS flows for a group of one or more second STAs, the first request frame includes QoS parameters associated with the QoS flow for the group; and
receiving, from the AP, the first response frame in response to the first request frame.

6. The first STA of claim 5, wherein the first request frame includes an identifier for the group of the one or more second STAs.

7. An access point (AP) in a wireless network, comprising:
a memory; and
a processor coupled to the memory, the processor configured to cause:
receiving, from a first station (STA), a first request frame that requests the AP to establish a quality of service (QoS) flow for a second STA, the first request frame including QoS parameters associated with the QoS flow;
transmitting, to the first STA, a first response frame in response to the first request frame; and
establishing the QoS flow for the second STA based on the QoS parameters included in the first request frame.

8. The AP of claim 7, wherein the processor is further configured to cause:
receiving, from the first STA, a declaration frame indicating that the second STA has authorized the first STA to establish the QoS flow on behalf of the second STA.

9. The AP of claim 7, wherein the processor is further configured to cause:
receiving, from the second STA, a declaration frame indicating that the second STA has authorized the first STA to establish the QoS flow on behalf of the second STA.

10. The AP of claim 7, wherein the processor is further configured to cause:
transmitting, to the second STA, a verification request frame to verify whether the second STA has authorized the first STA to establish the QoS flow on behalf of the second STA; and
receiving, from the second STA, a verification response frame to confirm that the second STA has authorized the first STA to establish the QoS flow on behalf of the second STA.

11. The AP of claim 8, wherein the declaration frame includes a list of identifiers of one or more STAs, including the second STA.

12. The AP of claim 7, wherein the processor is configured to cause:
receiving, from the AP, the first request frame that requests the AP to establish QoS flows for a group of one or more second STAs, the first request frame includes QoS parameters associated with the QoS flow for the group; and
transmitting, to the AP, the first response frame in response to the first request frame.

13. The AP of claim 12, wherein the first request frame includes an identifier for the group of the one or more second STAs.

14. The AP of claim 12, wherein the processor is further configured to cause:
allocating, to the group of the one or more second STAs, a transmission opportunity (TXOP) in response to the first request frame.

15. A method performed by a first station (STA) in a wireless network, the method comprising:
transmitting, to an access point (AP), a first request frame that requests the AP to establish a quality of service (QoS) flow for a second STA, the first request frame including QoS parameters associated with the QoS flow; and
receiving, from the AP, a first response frame in response to the first request frame.

16. The method of claim 15, further comprising:
transmitting, to the AP, a declaration frame indicating that the second STA has authorized the first STA to establish the QoS flow on behalf of the second STA.

17. The method of claim 16, wherein the declaration frame includes a list of identifiers for one or more STAs, including the second STA.

18. The method of claim 16, further comprising:
transmitting, to the second STA, a second request frame that requests permission to establish the QoS flow on behalf of the second STA; and
receiving, from the second STA, a second response frame that indicates permission to establish the QoS flow on behalf of the second STA.

19. The method of claim 15, further comprising:
transmitting, to the AP, the first request frame that requests the AP to establish QoS flows for a group of one or more second STAs, the first request frame including QoS parameters associated with the QoS flow for the group; and
receiving, from the AP, the first response frame in response to the first request frame.

20. The method of claim 19, wherein the first request frame includes an identifier for the group of the one or more second STAs.
